(19) United States
(12) Patent Application Publication
(10) Pub. No.: US 2018/0093468 A1
(43) Pub. Date: Apr. 5, 2018

(54) IMAGE FORMING SYSTEM AND IMAGE FORMING METHOD

(71) Applicant: KONICA MINOLTA, INC., Tokyo (JP)

(72) Inventor: Shingo SASAMI, Tokyo (JP)

(73) Assignee: KONICA MINOLTA, INC., Tokyo (JP)

(21) Appl. No.: 15/696,002

(22) Filed: Sep. 5, 2017

(30) Foreign Application Priority Data
Oct. 5, 2016 (JP) 2016-197478

(51) Int. Cl. B41F 33/16; B41F 16/00

(52) U.S. Cl. CPC B41F 33/16; B41F 16/0006

(57) ABSTRACT

An image forming system capable of performing foil stamping printing, which appropriately selects a color of a toner used as an adhesive on the basis of setting regarding the foil stamping printing, is provided. The image forming system includes an image former, a processor, and a foil transfer. The image former has a plurality of imaging units that form an image by toners of different colors. The processor is capable of receiving various types of setting regarding the foil stamping printing, and selects an image formation color, which is a color to be used for forming a foil stamping image, on the basis of the received setting. The foil transfer transfers a foil on the foil stamping image, which is formed by the image former, by using the toner of a color corresponding to the image formation color selected by the processor.

### CROSS-REFERENCE TO RELATED APPLICATION

Japanese Patent Application No. 2016-197478 filed on Oct. 5, 2016, including description, claims, drawings, and abstract, the entire disclosure is incorporated herein by reference in its entirety.

### BACKGROUND

### 1. Technological Field

The present invention relates to an image forming system and an image forming method.

### 2. Description of the Related Art

In recent years, an image forming system needs to output a high-value added printed matter in addition to the related color image or the like. As a technology for enhancing the added value of the printed matter, for example, there is known a foil stamping printing technology for transferring a foil on a toner image, which is formed on paper, by using a toner as an adhesive. See Japanese Patent Publication No. 2013-238733.

However, in this technology, a black toner is always used as an adhesive for foil stamping printing. Consequently, there is a problem that a color of an adhesive is seen through a foil according to a color or a thickness of the foil to be transferred. On the other hand, if a clear toner (a toner of a transparent color) is always used as an adhesive for example, a color of the adhesive is not seen through. However, since a specific color toner such as a clear toner is generally expensive, its excessive use is avoided.

Furthermore, if fixability of a foil to be transferred is not high, there is a case where a part of the foil is peeled off at an end portion of a foil image formed by the foil stamping printing. When the foil is peeled off, since a color of a toner used as an adhesive is seen, there is also a case where the peeled part is very conspicuous.

### SUMMARY

The present invention is achieved in view of the problems described above. Therefore, an object of the present invention is to provide an image forming system and an image forming method, by which a color of a toner used as an adhesive is appropriately selected on the basis of setting regarding foil stamping printing.

To achieve at least one of the abovementioned objects, according to an aspect of the present invention, an image forming system for performing foil stamping printing, reflecting one aspect of the present invention, comprises: an image former comprising a plurality of imaging units that form an image by toners of different colors; a hardware processor that is capable of receiving various types of setting regarding the foil stamping printing, and selects an image formation color, which is a color to be used for forming a foil stamping image being the image by the toners, on the basis of the received setting; and a foil transfer that transfers a foil on the foil stamping image, which is formed by the image former, by using the toner of a color corresponding to the image formation color selected by the hardware processor.

To achieve at least one of the abovementioned objects, according to an aspect of the present invention, an image forming method, which is performed in an image forming system for performing foil stamping printing, comprising an image former comprising a plurality of imaging units that form an image by toners of different colors and a foil transfer that transfers a foil onto a foil stamping image, which is formed by the image former and is the image by the toner, the image forming method, reflecting one aspect of the present invention, comprises: (a) receiving various types of setting regarding the foil stamping printing; (b) selecting an image formation color, which is a color to be used for forming the foil stamping image on the basis of the setting received in step (a); and (c) causing the image former to form the foil stamping image by using the toner of a color corresponding to the image formation color selected in step (b).

The objects, features, and characteristics of this invention other than those set forth above will become apparent from the description given herein below with reference to preferred embodiments illustrated in the accompanying drawings.

### BRIEF DESCRIPTION OF THE DRAWING

The advantages and features provided by one or more embodiments of the invention will become more fully understood from the detailed description given hereinbelow and the appended drawings which are given by way of illustration only, and thus are not intended as a definition of the limits of the present invention.

FIG. 1 is a diagram illustrating a schematic configuration of an image forming system according to an embodiment of the present invention.

FIG. 2 is a block diagram illustrating a schematic configuration of a paper feeding apparatus, an image forming apparatus, a foil stamping apparatus, and a post-processing apparatus.

FIG. 3 is a block diagram illustrating a functional configuration of a processor of an image forming apparatus.

FIG. 4 is a diagram illustrating an example of a setting screen of a print mode.

FIG. 5 is a diagram illustrating an example of a setting screen regarding foil stamping printing.

FIG. 6 is a flowchart illustrating a procedure of processes executed in an image forming system.

FIG. 7 is a sub-routine flowchart illustrating a procedure of an image formation color selection process illustrated in step S105 of FIG. 6.

FIG. 8 is a sub-routine flowchart illustrating a procedure of an image formation color selection process illustrated in step S105 of FIG. 6.

FIG. 9 is a diagram illustrating an example of an image formation color selection table.

### DETAILED DESCRIPTION OF EMBODIMENTS

Hereinafter, one or more embodiments of the present invention will be described with reference to the drawings. However, the scope of the invention is not limited to the disclosed embodiments.

In the description of the drawings, the same elements are denoted by the same reference numerals, and redundant description is omitted. In addition, in some cases, dimensional ratios in the drawings are exaggerated and different from actual ratios for convenience of the description.

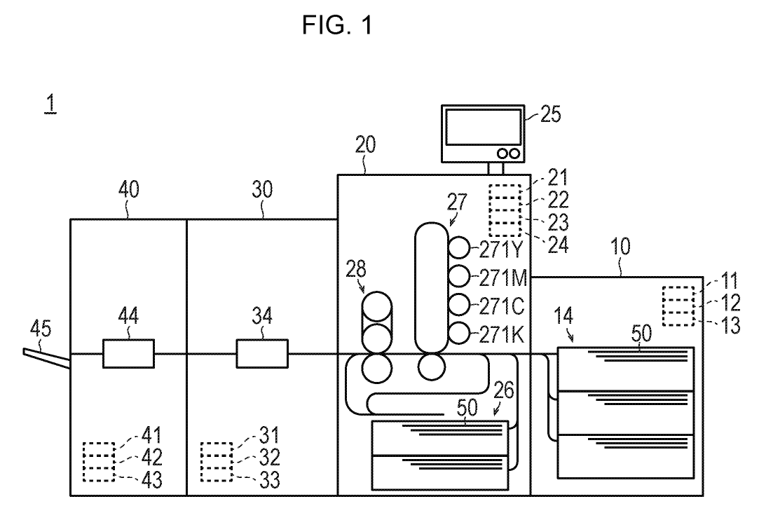

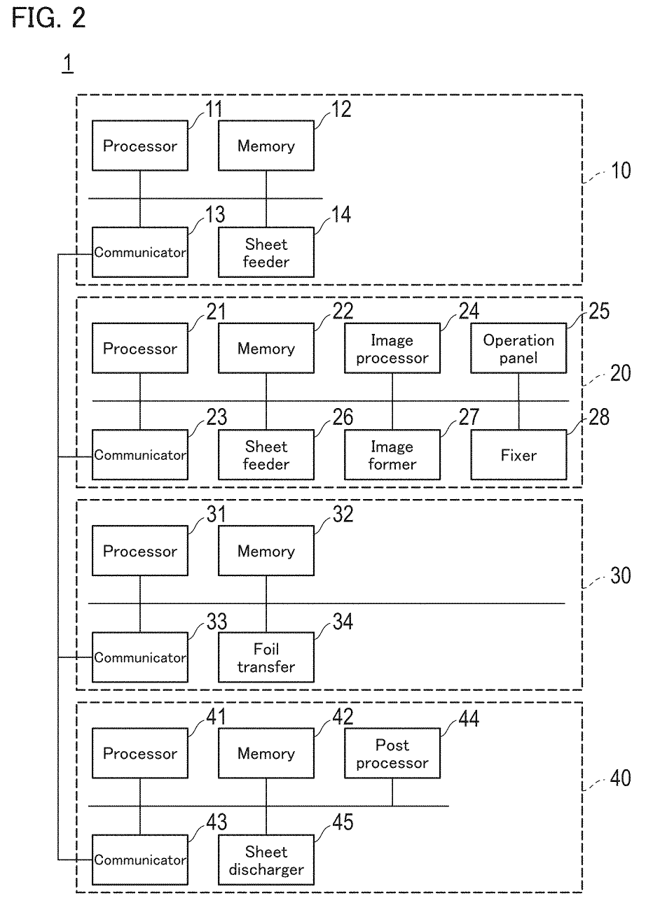

FIG. 1 is a diagram illustrating a schematic configuration of an image forming system according to an embodiment of the present invention. FIG. 2 is a block diagram illustrating a schematic configuration of a paper feeding apparatus, an image forming apparatus, a foil stamping apparatus, and a post-processing apparatus.

As illustrated in FIG. 1 and FIG. 2, an image forming system 1 comprises a paper feeding apparatus 10, an image forming apparatus 20, a foil stamping apparatus 30, and a post-processing apparatus 40. The paper feeding apparatus 10, the image forming apparatus 20, the foil stamping apparatus 30, and the post-processing apparatus 40 are connected to one another in an order from an upstream side to a downstream side of paper conveyance. Hereinafter, the image forming apparatus 20, the paper feeding apparatus 10, the foil stamping apparatus 30, and the post-processing apparatus 40 will be sequentially described.

The image forming apparatus 20 comprises a processor (hardware processor) 21, a memory 22, a communicator 23, an image processor 24, an operation panel 25, a sheet feeder 26, an image former 27, and a fixer 28. These are connected to one another via a bus for exchanging signals. The image forming apparatus 20 is an apparatus for forming an image on paper, which is a recording material, on the basis of image data by using a well-known imaging process such as an electrophotographic process.

The processor 21 is a CPU (Central Processing Unit) and performs control of each of the aforementioned elements and various arithmetic processes according to programs. The functional configuration of the processor 21 will be described later.

The memory 22 includes a ROM (Read Only Memory) for storing various programs and various pieces of data in advance, a RAM (Random Access Memory) serving as a work area to temporarily store programs and data, a hard disk for storing various programs and various pieces of data, or the like.

The communicator 23 is an interface for communicating with other devices, and transmits/receives setting values, various signals required for controlling operation timing, or the like to/from the paper feeding apparatus 10, the foil stamping apparatus 30, and the post-processing apparatus 40. The communicator 23 receives a print job including image data, or the like from a PC (Personal Computer) or the like of a user via a network.

The image processor 24 performs various types of image processing for the image data included in the print job as necessary. The image processor 24, for example, performs a rasterization process and the like for image data included in a print job received from the PC or the like of the user, thereby generating image data of a bitmap format.

The operation panel 25 comprises a touch panel, a numeric keypad, a start button, a stop button, and the like, and is used for displaying various pieces of information and inputting various instructions.

The sheet feeder 26 comprises a plurality of paper feeding trays for storing paper 50 which are recording materials used in printing, and feeds the paper 50 stored in the paper feeding tray to the image former 27 one by one.

The image former 27 forms an image based on various pieces of data on a transfer belt and transfers the image formed on the transfer belt onto the paper 50, by using a well-known imaging process such as an electrophotographic process including each process of charging, exposure, development, transfer, and fixing. The image former 27 forms a normal image or a foil stamping image on the paper 50 by using at least one of a plurality of toners on the basis of image data.

The image former 27 comprises an imaging unit 271Y for forming a yellow (Y) image, an imaging unit 271M for forming a magenta (M) image, an imaging unit 271C for forming a cyan (C) image, and an imaging unit 271K for forming a black (K) image. Each imaging unit comprises a photosensitive drum serving as an image carrying member, and a charging unit, an optical writing unit, a developing device, and a photosensitive drum cleaning device (all not illustrated) arranged around the photosensitive drum. Each photosensitive drum is rotated by a drum motor at a predetermined speed. Each developing device stores a developer including various colors of toners of a yellow, a magenta, a cyan, and a black.

In each imaging unit, the optical writing unit writes an image information signal based on image data of each color in the photosensitive drum, so that a latent image based on the image information signal is formed on the photosensitive drum. Then, the developing device develops the latent image, so that a toner image serving as a visible image is formed on the photosensitive drum. The imaging units 271Y, 271M, 271C, and 271K form yellow, magenta, cyan, and black toner images on the respective photosensitive drums.

In the present embodiment, the image former 27 may further comprise imaging units (not illustrated) in addition to the aforementioned imaging units 271Y, 271M, 271C, and 271K. Specifically, the image former 27 may also comprise at least one imaging unit including a toner of a specific color such as a clear or a white. The image former 27 can use these imaging units to output a higher-value added printed matter. For example, the image former 27 can use a clear toner in order to express glossy feeling or transparency, or use a white toner in order to enable white printing. An imaging unit including a specific color toner has a configuration similar to those of the aforementioned imaging units 271Y or the like.

The fixer 28 thermally fixes the image formed on the paper 50 by the image former 27. The fixer 28 comprises a pressure roller and a heating roller and presses and heats the paper 50 with the formed image, thereby fixing the image on the paper 50. The paper 50 with the image fixed by the fixer 28 is conveyed to the foil stamping apparatus 30.

Subsequently, the paper feeding apparatus 10 comprises a processor 11, a memory 12, a communicator 13, and a sheet feeder 14. These are connected to one another via a bus for exchanging signals. Since the processor 11, the memory 12, and the communicator 13 have functions similar to those of the processor 21, the memory 22, and the communicator 23 of the image forming apparatus 20, a description thereof is omitted.

The sheet feeder 14 comprises a plurality of paper feeding trays and feeds the paper 50 stored in the paper feeding tray to the image forming apparatus 20 one by one.

Subsequently, the foil stamping apparatus 30 comprises a processor 31, a memory 32, a communicator 33, and a foil transfer 34. These are connected to one another via a bus for exchanging signals. Since the processor 31, the memory 32, and the communicator 33 have functions similar to those of the processor 21, the memory 22, and the communicator 23 of the image forming apparatus 20, a description thereof is omitted.

The foil transfer 34 transfers a foil to a foil stamping image formed by a toner, thereby forming a foil image. The foil transfer 34, for example, conveys a foil film sheet with a foil film formed on the surface of a base and heats and press the foil film sheet superposed on the foil stamping image on the paper 50, thereby transferring a foil to the foil stamping image. The paper 50 with the foil transferred by the foil transfer 34 is conveyed to the post-processing apparatus 40.

Subsequently, the post-processing apparatus 40 comprises a processor 41, a memory 42, a communicator 43, a post-processor 44, and a sheet discharger 45. These are connected to one another via a bus for exchanging signals. Since the processor 41, the memory 42, and the communicator 43 have functions similar to those of the processor 21, the memory 22, and the communicator 23 of the image forming apparatus 20, a description thereof is omitted.

The post-processor 44 performs a post-process such as a staple process and a punching process with respect to the paper 50 conveyed from the foil stamping apparatus 30.

The sheet discharger 45 discharges the paper 50 to an exterior of the post-processing apparatus 40.

The paper feeding apparatus 10, the image forming apparatus 20, the foil stamping apparatus 30, and the post-processing apparatus 40 may include elements other than the aforementioned elements, or may not include some of the aforementioned elements.

As described above, the image forming system 1 according to the present embodiment transfers a foil to a foil stamping image formed by toners to perform foil stamping printing. Hereinafter, a processing flow of the foil stamping printing in the image forming system 1 will be described.

Firstly, the image forming apparatus 20 receives a print job including image data for a foil stamping printing in the state in which a print mode for performing foil stamping printing has been set. Then, the image forming apparatus 20 forms a foil stamping image on the paper 50 fed from the sheet feeder 26 or the sheet feeder 14 of the paper feeding apparatus 10. Subsequently, the foil stamping apparatus 30 transfers a foil to the formed foil stamping image on the paper 50, thereby forming a foil image. Finally, the post-processing apparatus 40 discharges the paper 50 with the formed foil image. By so doing, the image forming system 1 outputs a printed matter with the formed foil image.

In the case of forming both a foil image and a normal image on the paper 50, after the aforementioned foil image is formed, a user needs to set the discharged paper 50 in the sheet feeder 26 or the sheet feeder 14 again. The image forming apparatus 20 receives a print job including image data for normal printing in the state in which a print mode for performing the normal printing has been set instead of the foil stamping printing. Then, the image forming apparatus 20 forms a normal image on the paper 50 set again. In the normal printing, the foil stamping apparatus 30 does not transfer a foil and allows the paper 50 to pass therethrough. Finally, the post-processing apparatus 40 discharges the paper 50 having passed through the foil stamping apparatus 30. By so doing, the image forming system 1 outputs a printed matter with both the formed foil image and normal image.

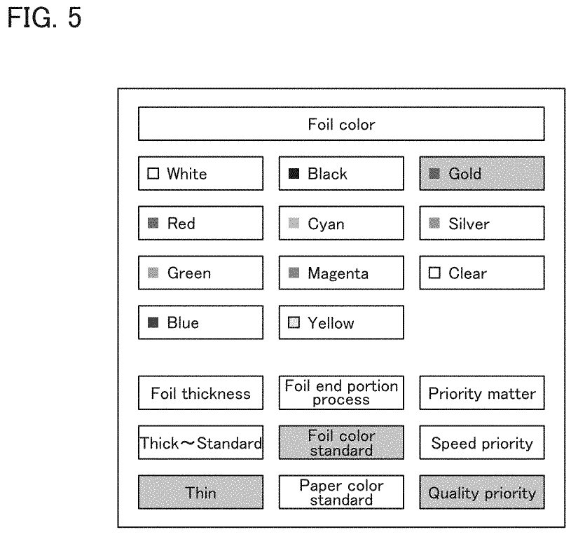

Subsequently, the functional configuration of the processor 21 of the image forming apparatus 20 will be described. Hereinafter, the functional configuration of the processor 21 will be described using FIG. 4 and FIG. 5.

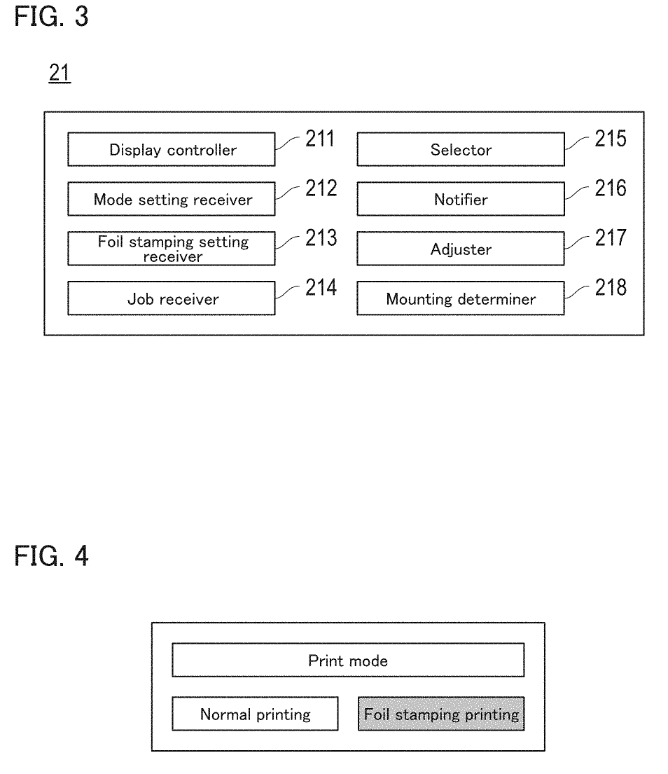

FIG. 3 is a block diagram illustrating the functional configuration of the processor of the image forming apparatus. FIG. 4 is a diagram illustrating an example of a setting screen of a print mode. FIG. 5 is a diagram illustrating an example of a setting screen regarding foil stamping printing.

In the present embodiment, the processor 21 of the image forming apparatus 20 reads a program to perform processes, thereby serving as a display controller 211, a mode setting receiver 212, a foil stamping setting receiver 213, a job receiver 214, a selector 215, a notifier 216, an adjuster 217, and a mounting determiner 218.

The display controller 211 controls a screen displayed on the operation panel 25 or the like. The display controller 211, for example, controls setting screens as illustrated in FIG. 4 and FIG. 5 to be displayed on the operation panel 25. Furthermore, the display controller 211 may control the setting screens as illustrated in FIG. 4 and FIG. 5 to be displayed on a PC or the like of a user via the communicator 23.

The mode setting receiver 212 receives setting of a print mode, which is selected by a user, on the setting screen as illustrated in FIG. 4. The setting of the print mode is performed by selecting either one of “normal printing” and “foil stamping printing”. In the setting of the print mode, since either one of the print modes needs to be selected, the setting is controlled such that a state in which both of them are not selected or both of them are selected does not occur.

The foil stamping setting receiver 213 receives various types of setting regarding the foil stamping printing, which is selected by a user, on the setting screen as illustrated in FIG. 5. In the present embodiment, the foil stamping setting receiver 213 receives setting of a color of a foil (a foil color), setting of a thickness of a foil (a foil thickness), setting regarding a process at an end portion of a foil image (a foil end portion process), setting of a priority matter in the foil stamping printing, or the like. Hereinafter, each setting will be described in detail.

The setting of the foil color is performed by selecting a foil color to be used in the foil stamping printing from candidates of a plurality of colors as illustrated in FIG. 5. In the setting of the foil color, since any one of the foil colors needs to be selected, the setting is controlled such that a state in which no foil color is selected or a plurality of foil colors are selected does not occur.

The setting of the foil thickness is performed by selecting either one of “thick˜standard” and “thin” with respect to a foil thickness to be used in the foil stamping printing. In the setting of the foil thickness, since either one the foil thicknesses needs to be selected, the setting is controlled such that a state in which both of them are not selected or both of them are selected does not occur. In an example, when a foil thickness to be used in the foil stamping printing is about 30 nm to 120 nm, a foil thickness corresponding to the “thick˜standard” may be equal to or more than 50 nm, or a foil thickness corresponding to the “thin” may be smaller than 50 nm.

The setting of the foil end portion process is performed by selecting either one of “foil color standard” and “paper color standard”. In the setting of the foil end portion process, since either one of the foil end portion processes needs to be selected, the setting is controlled such that a state in which both of them are not selected or both of them are selected does not occur.

The foil end portion process is a process for changing a color of a toner to be used for forming an end portion of the foil stamping image (hereinafter, referred to “end portion image formation color”) to a color different from an image formation color to be used for forming portions other than the end portion. The end portion of the foil stamping image means a constant width of range on the foil stamping image, which abuts an outer periphery of the foil stamping image. For example, when the foil stamping image has a round shape, an end portion of the foil stamping image has a donut shape having a constant width. Furthermore, a dimension of a width serving as the end portion may be set by a user through the operation panel 25 or the like, or may be set as an initial value in advance. Hereinafter, a part, other than the end portion in the foil stamping image, may be called a “center part”. By this foil end portion process, independent image formation colors can be respectively set in the center part and the end portion of the foil stamping image.

The foil end portion process of the “foil color standard” is a process for changing the end portion image formation color to a color corresponding to a color selected in the setting of the foil color. The foil end portion process of the “foil color standard” is valid when a foil is easily peeled off at an end portion of a foil image. If the end portion image formation color corresponds to a foil color, even when the foil is peeled off at the end portion of the foil image, it is possible to minimize an influence in which the foil image is seen to be missed.

For example, it is assumed that a foil color to be used in foil stamping printing is a red color, a color of the paper 50 (a paper color) is a white color, and the end portion image formation color is a color other than the red color. In this case, if a foil is peeled off at an end portion of a foil image, since a color different from the foil color is seen from the peeled part, the foil image is seen to be missed. On the other hand, when the foil end portion process of the “foil color standard” is applied and the end portion image formation color is changed to a red color, even if a foil is peeled off at an end portion of the foil image, since the red color corresponding to the foil color is seen from the peeled part, the foil image is not easily seen to be missed. From such a reason, the foil stamping setting receiver 213 can receive the setting of the “foil color standard”.

The foil end portion process of the “paper color standard” is a process for changing the end portion image formation color to a color corresponding to a paper color or a transparent color. The foil end portion process of the “paper color standard” is valid when a thickness of a foil tends to be insufficient and the end portion image formation color is easily seen through a foil at an end portion of a foil image. If the end portion image formation color is the transparent color or a color corresponding to a paper color, even when the thickness of the foil is insufficient at the end portion of the foil image, it is possible to minimize an influence in which the end portion image formation color is seen through.

For example, it is assumed that a foil color to be used in foil stamping printing is a red color, a paper color is a white color, and the end portion image formation color is a black color. In this case, if a thickness of a foil is insufficient at an end portion of a foil image, the black color of the end portion image formation color is seen through. On the other hand, when the foil end portion process of the “paper color standard” is applied and the end portion image formation color is changed to a transparent color or a white color, even if the thickness of the foil lacks at the end portion of the foil image, the end portion image formation color is not easily seen through. From such a reason, the foil stamping setting receiver 213 can receive the setting of the “paper color standard”.

The setting of the priority matter is performed by selecting either one of “speed priority” and “quality priority”. In the setting of the priority matter, since either one of the priority matters needs to be selected, the setting is controlled such that a state in which both of them are not selected or both of them are selected does not occur. The setting of the priority matter is setting which is referred to only when a color to be used for forming at least a part of the foil stamping image is a color configured by a plurality of toners of different colors. For example, it corresponds to a case where the center part of the foil stamping image is formed in a red color by using the same amount of magenta and yellow toners, or the like.

The reason for receiving the setting of the priority matter is as follows. When a color used for forming at least a part of the foil stamping image is a color configured by a plurality of toners, the total amount of the plurality of toners used for forming the part is larger than an amount of used toner when the same part is formed using one toner. For example, when the entire foil stamping image is formed in a red color by using the same amount of magenta and yellow toners, the total amount of used toners is twice as much as an amount of used toner when the same image is formed using only the magenta toner. Consequently, in this case, since an amount of used toner serving as an adhesive increases and a time is required for melting a toner in heating in the foil transfer 34, it is probable that a foil will not be clearly transferred.

In this regard, the image forming system 1 of the present embodiment proposes two processes for solving the aforementioned problem. The first process is a process for reducing a transfer speed of a foil (a foil transfer speed), which is performed when the priority matter of the “quality priority” has been set. In this case, the image forming system 1 reduces the foil transfer speed in order to ensure a time sufficient for melting an increased toner. The second process is a process for reducing image density of the foil stamping image, which is performed when the priority matter of the “speed priority” has been set. In this case, the image forming system 1 reduces the total amount of used toners by reducing the image density of the foil stamping image instead of reducing the foil transfer speed. The image forming system 1 is configured to perform either one of the aforementioned two processes and to be able to clearly transfer a foil even when an amount of used toner serving as an adhesive increases.

The job receiver 214 receives a print job transmitted from a PC or the like of a user via the communicator 23.

The selector 215 selects a color to be used for forming the foil stamping image (hereinafter, referred to as “image formation color”) on the basis of various types of setting regarding foil stamping printing received by the foil stamping setting receiver 213. Furthermore, the selector 215 controls the image former 27 to form the foil stamping image by using a toner of a color corresponding to the selected image formation color. The selector 215 may generate image data obtained by replacing a color originally used in data of the foil stamping image with the selected image formation color, and control the image former 27 to form the foil stamping image on the basis of the image data. Alternatively, the selector 215 may cause an arbitrary configuration such as the image processor 24 to generate image data obtained by replacing the image formation color.

The notifier 216 notifies the foil stamping apparatus 30 that the foil transfer speed in the foil transfer 34 is needed to be adjusted via the communicator 23 as necessary. A required adjustment amount of the foil transfer speed may be set by a user through the operation panel 25 or the like, or may be set as an initial value in advance. For example, when the total amount of a plurality of toners used for forming at least a part of the foil stamping image is twice as much as an amount of used toner when the same part is formed using one toner, the notifier 216 may require the foil transfer speed to increase twice.

The adjuster 217 generates image data obtained by adjusting image density of at least a part of data of the foil stamping image as necessary. Alternatively, the adjuster 217 may cause an arbitrary configuration such as the image processor 24 to generate image data obtained by adjusting image density. For example, when the total amount of a plurality of toners used for forming at least a part of the foil stamping image is twice as much as an amount of used toner when the same part is formed using one toner, the adjuster 217 may adjust image density of the part to 50%.

The mounting determiner 218 acquires information of the imaging units mounted on the image former 27 and determines whether a predetermined imaging unit has been mounted.

Next, processing in the image forming system 1 will be described.

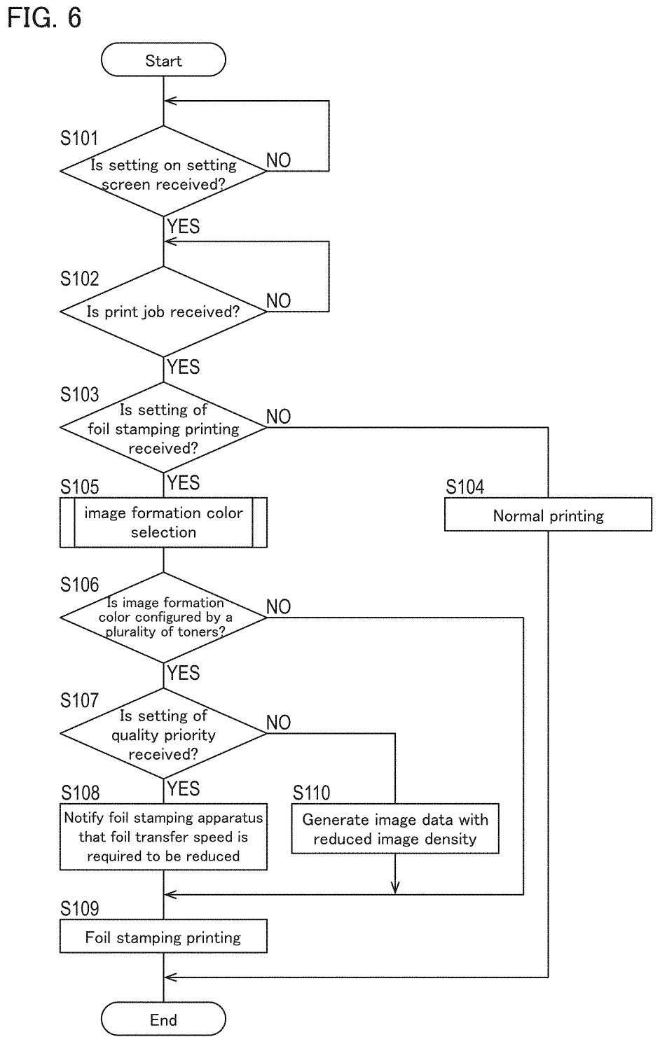

FIG. 6 is a flowchart illustrating a procedure of processes executed in the image forming system.

An algorithm illustrated in the flowchart of FIG. 6 is stored in the memory 22 of the image forming apparatus 20 as a program and is executed by the processor 21. The procedure illustrated in the flowchart of FIG. 6 is based on a situation that a color of the paper 50 to be subjected to foil stamping printing is a white color or a color near the white color.

As illustrated in FIG. 6, the processor 21 first serves as the display controller 211 to allow the setting screens as illustrated in FIG. 4 and FIG. 5 to be displayed, and serves as the mode setting receiver 212 and the foil stamping setting receiver 213 to determine whether setting on the setting screen has been received (step S101). Specifically, the processor 21 allows the setting screens as illustrated in FIG. 4 and FIG. 5 to be displayed on the operation panel 25, a PC of a user, or the like. Then, the processor 21 determines whether the setting of the print mode as illustrated in FIG. 4 and various types of setting regarding the foil stamping printing as illustrated in FIG. 5 are received from a user. In addition, the processor 21 may allow the setting screens as illustrated in FIG. 4 and FIG. 5 to be simultaneously displayed. Alternatively, the processor 21 may allow the setting screen of the print mode as illustrated in FIG. 4 to be first displayed, and only when the setting of the “foil stamping printing” on the setting screen is received, the processor 21 may allow the setting screens regarding the foil stamping printing as illustrated in FIG. 5 to be displayed. This is because the setting regarding the foil stamping printing is setting which is referred to only when the print mode is the “foil stamping printing”.

In step S101, when the setting on the setting screen has not been received (step S101: NO), the processor 21 waits until the setting is received.

When the setting on the setting screen has been received (step S101: YES), the processor 21 serves as the job receiver 214 to determine whether a print job has been received (step S102).

When the print job has not been received (step S102: NO), the processor 21 waits until the print job is received.

When the print job has been received (step S102: YES), the processor 21 determines whether the setting of the “foil stamping printing” has been received when serving as the mode setting receiver 212 in step S101 (step S103).

When the setting of the foil stamping printing has not been received (step S103: NO), that is, when the setting of the normal printing has been received, the processor 21 executes a process for performing the normal printing (step S104). Then, the processor 21 ends the procedure.

When the setting of the foil stamping printing has been received (step S103: YES), the processor 21 proceeds to an image formation color selection process (step S105) in order to select the image formation color which is a color to be used for forming the foil stamping image. Details of the process of step S105 will be described later.

After selecting the image formation color in step S105, the processor 21 determines whether the image formation color, which has been selected when serving as the selector 215 and is used for forming at least a part of the foil stamping image, is a color configured by a plurality of toners of different colors one another (step S106).

When the image formation color to be used for forming at least a part is the color configured by a plurality of toners (step S106: YES), the processor 21 proceeds to a process of step S107. Then, the processor 21 determines whether the setting of the priority matter of the “quality priority” has been received when serving as the foil stamping setting receiver 213 in step S101 (step S107).

When the setting of the “quality priority” has been received (step S107: YES), the processor 21 proceeds to a process of step S108. Then, the processor 21 serves as the notifier 216 to notify the foil stamping apparatus 30 that a foil transfer speed in the foil transfer 34 is required to be reduced (step S108). When the fact that the foil transfer speed is required to be reduced has been received from the processor 21, the processor 31 of the foil stamping apparatus 30 controls the foil transfer 34 to reduce the foil transfer speed. Subsequently, the processor 21 serves as the selector 215 to control the image former 27 to form the foil stamping image on the paper 50 by using a toner of a color corresponding to the image formation color selected in step S105, to execute a process for performing foil stamping printing (step S109). Then, the processor 21 ends the procedure.

When the setting of the “quality priority” has not been received (step S107: NO), that is, when the setting of the “speed priority” has been received, the processor 21 proceeds to a process of step S110. Then, the processor 21 serves as the adjuster 217 to generate image data obtained by reducing image density of a part which uses the color configured by the plurality of toners (step S110). Alternatively, as described above, the processor 21 may cause the image processor 24 or the like to generate the image data. Subsequently, the processor 21 serves as the selector 215 to control the image former 27 to form the foil stamping image on the paper 50 by using the toner of the color corresponding to the image formation color selected in step S105, to execute the process for performing foil stamping printing (step S109). The image former 27 forms the foil stamping image on the basis of the image data with the reduced image density, that is, with a reduced toner amount. Thereafter, the processor 21 ends the procedure.

In step S106, when the image formation color to be used for forming at least a part is not the color configured by the plurality of toners (step S106: NO), that is, when the image formation color is a color of one toner, the processor 21 proceeds to the process of step S109 as is. Then, the processor 21 serves as the selector 215 to control the image former 27 to form the foil stamping image on the paper 50 by using the toner of the color corresponding to the image formation color selected in step S105, to execute the process for performing foil stamping printing (step S109). Thereafter, the processor 21 ends the procedure.

Subsequently, a detailed process of the image formation color selection of step S105 will be described.

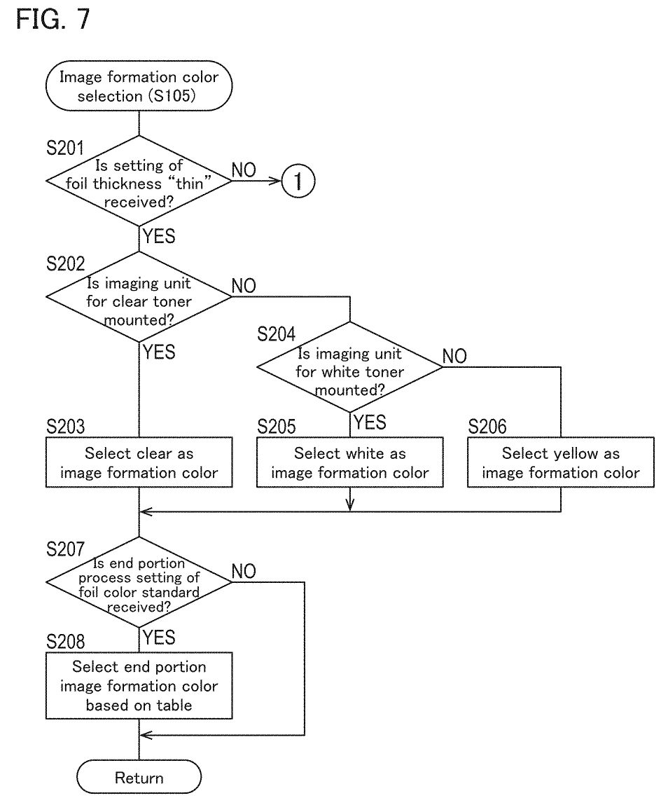

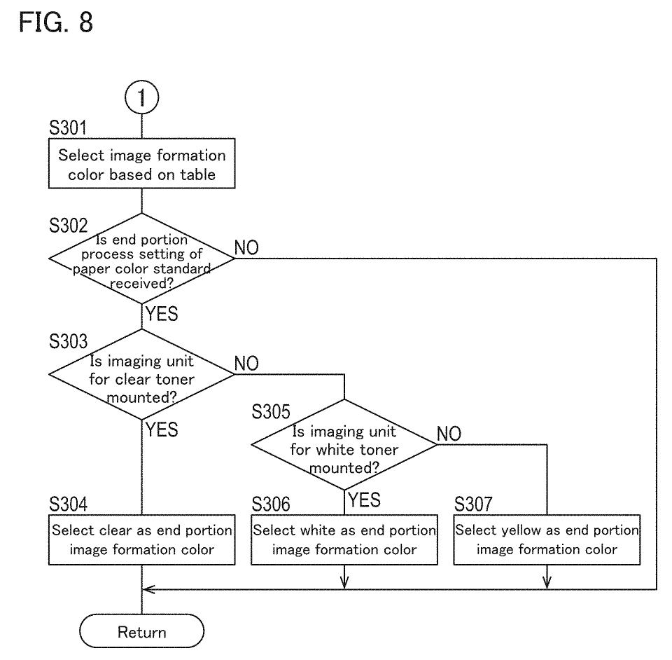

FIG. 7 and FIG. 8 are sub-routine flowcharts illustrating a procedure of the image formation color selection process in step S105 of FIG. 6.

As illustrated in FIG. 7, the processor 21 first determines whether the setting of the foil thickness “thin” has been received when serving as the foil stamping setting receiver 213 in step S101 (step S201).

When the setting of the foil thickness “thin” has not been received (step S201: NO), that is, when setting of “thick˜standard” has been received, the processor 21 proceeds to the procedure of FIG. 8. The procedure of FIG. 8 will be described later.

When the setting of the foil thickness “thin” has been received (step S201: YES), the processor 21 proceeds to a process of step S202. Then, the processor 21 serves as the mounting determiner 218 to determine whether an imaging unit for forming an image by a clear toner (toner of a transparent color) (an imaging unit for a clear toner) has been mounted on the image former 27 (step S202).

When the imaging unit for the clear toner has been mounted on the image former 27 (step S202: YES), the processor 21 serves as the selector 215 to select a clear (a transparent color) as the image formation color (step S203).

When the imaging unit for the clear toner has not been mounted on the image former 27 (step S202: NO), the processor 21 proceeds to a process of step S204. Then, the processor 21 serves as the mounting determiner 218 to determine whether an imaging unit for a white toner (toner of a white color) has been mounted on the image former 27 (step S204).

When the imaging unit for the white toner has been mounted on the image former 27 (step S204: YES), the processor 21 serves as the selector 215 to select a white (a white color) as the image formation color (step S205).

When the imaging unit for the white toner has not been mounted on the image former 27 (step S204: NO), the processor 21 serves as the selector 215 to select a yellow (a yellow color) as the image formation color (step S206).

The processes of steps S202 to S206 are performed when the processor 21 receives the setting of the foil thickness “thin” (step S201: YES). In this case, the processor 21 selects the image formation color in a priority sequence of a clear, a white, and a yellow. When both the imaging units for the clear toner and the white toner have not been mounted on the image former 27, the processor 21 selects a yellow from toner colors of basic colors which are generally considered to be mounted.

Subsequently, the processor 21 determines whether to change only an image formation color which is used for forming an end portion of the foil stamping image (an end portion image formation color), with respect to the image formation color selected in steps S202 to S206. The processor 21 determines whether the setting of the foil end portion process of the “foil color standard” has been received when serving as the foil stamping setting receiver 213 in step S101 (step S207).

When the setting of the “foil color standard” has been received (step S207: YES), the processor 21 proceeds to a process of step S208. Then, the processor 21 confirms the setting of the foil color received when serving as the foil stamping setting receiver 213 in step S101, and serves as the selector 215 to select the end portion image formation color on the basis of the foil color and an image formation color selection table to be described later (step S208). In this case, the processor 21 changes only the end portion image formation color. Then, the processor 21 returns to the procedure of FIG. 6.

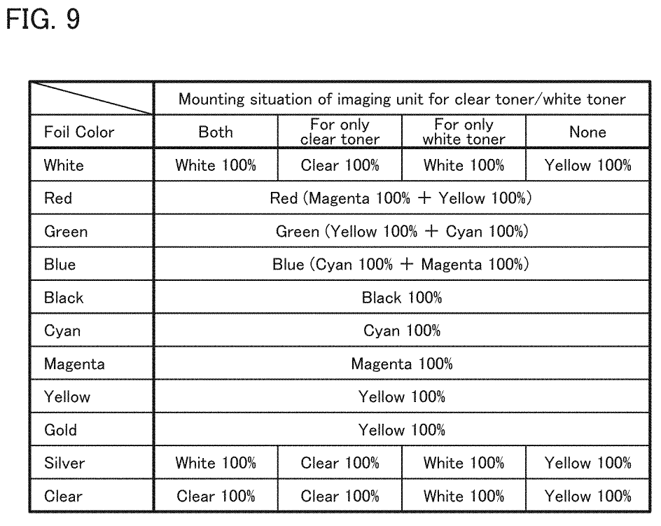

FIG. 9 is a diagram illustrating an example of the image formation color selection table.

As illustrated in FIG. 9, the image formation color selection table is a table for deciding the image formation color according to the foil color to be used in the foil stamping printing and a mounting situation of an imaging unit for a clear toner and/or an imaging unit for a white toner in the image former 27. On the basis of the table, the processor 21 selects the foil color to be used in the foil stamping printing or a color near the foil color as the image formation color. For example, when the setting of a cyan as the foil color has been received in step S101, the processor 21 selects the cyan as the end portion image formation color in step S208 regardless of the mounting situation of the imaging unit for a clear toner and/or the imaging unit for a white toner. Furthermore, when the setting of a red as the foil color has been received, the processor 21 selects the red configured by using the same amount of two toners, i.e., magenta and yellow toners as the end portion image formation color. Furthermore, when the setting of a white or a clear as the foil color has been received, the processor 21 puts a color near the foil color into candidates as well as the foil color itself in consideration of a situation that the imaging unit for a clear toner and/or the imaging unit for a white toner has not been mounted. Furthermore, when the setting of a gold or a silver as the foil color has been received, the processor 21 selects a toner color near the foil color as the end portion image formation color.

In step S207, when the setting of the “foil color standard” has not been received (step S207: NO), that is, when the setting of the “paper color standard” has been received, the processor 21 returns to the procedure of FIG. 6 as is. In this case, since the processor 21 does not change the end portion image formation color, the end portion image formation color is equal to an image formation color of a center part. That is, since the image formation colors selected in steps S202 to S206 are already image formation colors of the “paper color standard”, the processor 21 does not need to change the end portion image formation color.

Subsequently, a description will be provided for the procedure of FIG. 8 when the setting of the foil thickness “thin” has not been received (step S201 of FIG. 7: NO). The processor 21 confirms the setting of the foil color received when serving as the foil stamping setting receiver 213 in step S101, and serves as the selector 215 to select the image formation color on the basis of the foil color and the aforementioned image formation color selection table (FIG. 9) (step S301 of FIG. 8).

Subsequently, the processor 21 determines whether to change only the end portion image formation color with respect to the image formation color selected in step S301. The processor 21 determines whether the setting of the foil end portion process of the “paper color standard” has been received when serving as the foil stamping setting receiver 213 in step S101 (step S302).

When the setting of the “paper color standard” has been received (step S302: YES), the processor 21 proceeds to a process of step S303. In this case, the processor 21 changes only the end portion image formation color. Then, the processor 21 serves as the mounting determiner 218 to determine whether the imaging unit for the clear toner has been mounted on the image former 27 (step S303).

When the imaging unit for the clear toner has been mounted on the image former 27 (step S303: YES), the processor 21 serves as the selector 215 to select the clear as the end portion image formation color (step S304). Then, the processor 21 returns to the procedure of FIG. 6.

When the imaging unit for the clear toner has not been mounted on the image former 27 (step S303: NO), the processor 21 proceeds to a process of step S305. Then, the processor 21 serves as the mounting determiner 218 to determine whether the imaging unit for the white toner has been mounted on the image former 27 (step S305).

When the imaging unit for the white toner has been mounted on the image former 27 (step S305: YES), the processor 21 serves as the selector 215 to select the white as the end portion image formation color (step S306). Then, the processor 21 returns to the procedure of FIG. 6.

When the imaging unit for the white toner has not been mounted on the image former 27 (step S305: NO), the processor 21 serves as the selector 215 to select the yellow as the end portion image formation color (step S307). Then, the processor 21 returns to the procedure of FIG. 6.

In step S302, when the setting of the “paper color standard” has not been received (step S302: NO), that is, when the setting of the “foil color standard” has been received, the processor 21 returns to the procedure of FIG. 6 as is. In this case, since the processor 21 does not change the end portion image formation color, the end portion image formation color is equal to an image formation color of a center part. That is, since the image formation color selected in step S301 is already an image formation color of the “foil color standard”, the processor 21 does not need to change the end portion image formation color.

As described above, according to the image forming system 1, various types of setting regarding the foil stamping printing is received and an image formation color to be used for forming the foil stamping image is selected on the basis of the received setting. Consequently, the image forming system 1 can select an image formation color which is not seen through a foil to be transferred or an image formation color for preventing a peeled part from being conspicuous even when a foil is peeled off, thereby improving quality of a foil image. Furthermore, according to the image forming system 1, since it is not always necessary to select a transparent color as an image formation color in order to prevent an image formation color from being seen through a foil, it is also possible to avoid an increase in cost when a clear toner is always used.

Furthermore, the image forming system 1 forms a foil stamping image on the basis of image data obtained by replacing a color originally used in image data to be used for forming the foil stamping image with a selected image formation color. Consequently, in the image forming system 1, even when the same foil image is formed on a plurality of paper 50, the selection process of an image formation color is not needed to be repeated since each color of image data is replaced.

Furthermore, when the setting of the foil thickness “thin” is received, the image forming system 1 preferentially selects a transparent color as an image formation color. When a foil to be used in the foil stamping printing is thin, the image formation color is easily seen through the thin foil. The image forming system 1 can preferentially select the transparent color as the image formation color, thereby preventing the image formation color from being seen through, even when the foil is thin. In addition, according to the image forming system 1, even when a clear toner is not provided, if white and yellow toners are provided, it is possible to achieve similar effects by using these toners.

Furthermore, when the setting of the foil thickness “thin” is not received, the image forming system 1 selects a foil color or a color near the foil color as an image formation color on the basis of the setting of the foil color. When a foil to be used in the foil stamping printing is not thin, the image formation color is not easily seen through as the foil is thin. Consequently, even if the image forming system 1 does not always select the transparent color as the image formation color, there is a case where it is possible to achieve a sufficient seeing-through prevention effect by selecting the foil color or a color near the foil color. Consequently, when the foil is not thin, the image forming system 1 selects the foil color or a color near the foil color as the image formation color, thereby causing no change in color tone of a foil image.

Furthermore, the image forming system 1 can receive setting of a change of only an end portion image formation color after selecting an image formation color. The image forming system 1 changes the end portion image formation color to the foil color or a color near the foil color, so that it is possible to minimize an influence in which the foil image is seen to be missed, since an image formation color corresponding to a foil color can be seen from the peeled part even when a foil is peeled off at an end portion of a foil image. Furthermore, the image forming system 1 changes the end portion image formation color to a transparent color, so that it is possible to minimize an influence in which the image formation color is seen through, even when the thickness of a foil is not sufficient at the end portion of the foil image. A user of the image forming system 1 can select an optimal foil end portion process according to features of a foil such as ease in peeling off or difficulty in fixing, thereby improving quality of a foil image.

Furthermore, when there is no imaging unit for forming an image by a toner of an image formation color to be selected, the image forming system 1 selects a yellow color as the image formation color. Consequently, even when there is no specific color toner such as a clear toner and a white toner, the image forming system 1 can implement the present embodiment. The image forming system 1 can select a yellow near a clear or a white from toner colors of basic colors which are generally considered to be mounted, so that it is possible to minimize an influence in which the image formation color is seen through, even when a foil is thin.

Furthermore, when an image formation color to be used for forming at least a part of a foil stamping image is a color configured by a plurality of toners of different colors, the image forming system 1 generates image data obtained by reducing image density of a part which uses the color configured by the plurality of toners. Then, the image forming system 1 forms the foil stamping image on the basis of the image data with the reduced image density. Consequently, even when the image formation color configured by a plurality of toners is used, the image forming system 1 can clearly transfer a foil without increasing an amount of toner to be used as an adhesive.

Furthermore, when the image formation color to be used for forming at least a part of the foil stamping image is a color configured by a plurality of toners of different colors, the image forming system 1 reduces the foil transfer speed and transfers a foil. Consequently, even when the image formation color configured by the plurality of toners is used, the image forming system 1 ensures a time sufficient for melting a toner, so that it is possible to clearly transfer the foil.

In the aforementioned embodiment, an example of a procedure of processing in the image forming system 1 has been described. However, the present embodiment is not limited thereto. The following various changes, improvements or the like can be made.

The image forming system 1 may receive only the setting of the foil thickness in step S101. In this case, it is sufficient if the image forming system 1 refers to only the setting of the foil thickness in the image formation color selection process of step S105. When the setting of the foil thickness “thin” is received (step S201: YES), the image forming system 1 performs the processes of steps S202 to S206, and then returns to the procedure of FIG. 6 by omitting steps S207 and S208. On the other hand, when the setting of the foil thickness “thick˜standard” is received (step S201: NO), the image forming system 1 returns to the procedure of FIG. 6 as is. The image forming system 1 may be configured to refer to only the setting of the foil thickness, when a user determines that it is not necessary to pay attention to seeing-through of the image formation color if the foil thickness is not thin. The image forming system 1 receives only the setting of the foil thickness, so that an optimal image formation color can be selected with a simple process.

Furthermore, the image forming system 1 may receive only the setting of the foil color in step S101. In this case, it is sufficient if the image forming system 1 refers to only the setting of the foil color in the image formation color selection process of step S105. Then, the image forming system 1 proceeds to FIG. 8 by omitting step S201, performs only the process of step S301, and returns to the procedure of FIG. 6. When a user determines that it is possible to sufficiently prevent seeing-through of the image formation color if the image formation color is adjusted to a foil color, the image forming system 1 may be configured to refer to only the setting of the foil color. The image forming system 1 receives only the setting of the foil color, so that an optimal image formation color can be selected with a simple process.

Furthermore, the image forming system 1 may receive only the setting of the foil end portion process of the “paper color standard”. In this case, it is sufficient if the image forming system 1 refers to only the setting of the foil end portion process in the image formation color selection process of step S105. Then, the image forming system 1 proceeds to FIG. 8 by omitting step S201, performs the processes of steps S302 to S307 by further omitting the process of step S301, and returns to the procedure of FIG. 6. When a user determines that it is sufficient if it is possible to improve seeing-through of an image formation color due to insufficiency of a foil thickness at an end portion of a foil image, the image forming system 1 may be configured to refer to only the setting of the “paper color standard”. The image forming system 1 receives only the setting of the “paper color standard”, so that seeing-through of an image formation color at the end portion can be selected with a simpler process.

Furthermore, the image forming system 1 may omit only the foil end portion processes of steps S207 and S208 and steps S302 to S307. When a user determines that there is no problem that a foil is easily peeled off or a thickness of the foil is easily insufficient at a foil end portion, the image forming system 1 may be configured to omit these processes.

Furthermore, the image forming system 1 may omit only the process regarding the foil thickness of steps S201. When a user determines that it is possible to comprehensively solve the problem in the foil stamping printing if either one procedure of FIG. 7 and FIG. 8 is performed, the image forming system 1 may be configured to omit either one procedure.

Furthermore, the aforementioned embodiment has been described on the assumption that a color (a paper color) of the paper 50 to be subjected to the foil stamping printing is a white color or a color near the white color. However, the present embodiment is not limited thereto. The present embodiment is also applied even when the paper color is different colors. Specifically, it is sufficient if the image forming system 1 selects a color corresponding to the paper color as the image formation color instead of performing the processes of steps S204 to S206. Furthermore, it is sufficient if the image forming system 1 selects a color corresponding to the paper color as the end portion image formation color instead of performing the processes of steps S305 to S307. As a method for selecting the color corresponding to the paper color, it is sufficient if it is determined to replace a foil color with the paper color in the table as illustrated in FIG. 9. In addition, when the paper color is a silver or a clear, processes similar to those of steps S204 to S206 or steps S305 to S307 are necessary.

Furthermore, the aforementioned embodiment has been described based on the assumption that the image forming apparatus 20 or the like in the image forming system 1 is one apparatus. However, the present invention is not limited thereto. For example, for the image forming apparatus 20, an information processing apparatus for performing the image formation color selection process or the like and an apparatus for performing the image formation process may be separately configured. In this case, the information processing apparatus and the apparatus for performing the image formation process are connected to each other via a bus.

Means and a method for performing various processes in the image forming system 1 according to the above-described embodiment can also be realized by both of a dedicated hardware circuit or a programmed computer. The aforementioned program, for example, may also be provided by a computer readable recording medium such as a USB memory, a flexible disk, and CD-ROM (Compact Disk Read Only Memory), or may also be provided on-line via a network such as the Internet. In this case, the program recorded in the computer readable recording medium is normally transmitted to and stored in a storage unit such as a hard disk. Furthermore, the aforementioned program may also be provided as single application software or may also be incorporated in software of each apparatus of the image forming system 1 as one function of the image forming system 1.

Although embodiments of the present invention have been described and illustrated in detail, it is clearly understood that the same is by way of illustration and example only and not limitation, the scope of the present invention should be interpreted by terms of the appended claims.

What is claimed is:

1. An image forming system for performing foil stamping printing, comprising:
an image former comprising a plurality of imaging units that form an image by toners of different colors;
a hardware processor that is capable of receiving various types of setting regarding the foil stamping printing, and selects an image formation color, which is a color to be used for forming a foil stamping image being the image by the toners, on the basis of the received setting; and
a foil transfer that transfers a foil on the foil stamping image, which is formed by the image former, by using the toner of a color corresponding to the image formation color selected by the hardware processor.

2. The image forming system according to claim 1, wherein the image former forms the foil stamping image on the basis of image data obtained by replacing a color used in image data to be used for forming the foil stamping image with the image formation color selected by the hardware processor.

3. The image forming system according to claim 1, wherein the plurality of imaging units include an imaging unit for forming an image by the toner of a transparent color, and
the hardware processor is capable of receiving setting of a thickness of the foil used in the foil transfer and preferentially selects the transparent color as the image formation color when receiving setting that the thickness of the foil is thin.

4. The image forming system according to claim 1, wherein the hardware processor is capable of receiving setting of a foil color, which is a color of the foil used in the foil transfer, and selects the received foil color or a color near the foil color as the image formation color.

5. The image forming system according to claim 1, wherein the plurality of imaging units include an imaging unit for forming an image by the toner of a transparent color, and
the hardware processor is capable of receiving setting that the image formation color used for forming an end portion of the foil stamping image is changed to a color different from the image formation color used for forming portions other than the end portion and changes the image formation color used for forming the end portion to the transparent color when receiving setting that the image formation color used for forming the end portion is changed to the transparent color.

6. The image forming system according to claim 1, wherein the plurality of imaging units include an imaging unit for forming an image by the toner of a transparent color, and
the hardware processor is capable of receiving setting of a foil color, which is a color of the foil used in the foil transfer, and setting of a thickness of the foil used in the foil transfer, preferentially selects the transparent color as the image formation color regardless of the received setting of the foil color when receiving setting that the thickness of the foil is thin, and selects the received foil color or a color near the foil color as the image formation color when not receiving the setting that the thickness of the foil is thin.

7. The image forming system according to claim 6, wherein the hardware processor is capable of further receiving setting that the image formation color used for forming an end portion of the foil stamping image is changed to a color different from the image formation color used for forming portions other than the end portion, preferentially selects the transparent color as the image formation color and changes the image formation color used for forming the end portion to the foil color or the color near the foil color when receiving the setting that the thickness of the foil is thin and setting that the image formation color used for forming the end portion is changed to the foil color or the color near the foil color, and selects the received foil color or the color near the foil color as the image formation color and changes the image formation color used for forming the end portion to the transparent color when not receiving the setting that the thickness of the foil is thin and receiving setting that the image formation color used for forming the end portion is changed to the transparent color.

8. The image forming system according to claim 1, wherein, when the image former does not comprise an imaging unit for forming an image by the toner of the image formation color to be selected, the hardware processor selects a yellow color as the image formation color.

9. The image forming system according to claim 1, wherein, when the image formation color selected by the hardware processor and used for forming at least a part of the foil stamping image is a color configured by a plurality of the toners of different colors, the image former forms the foil stamping image on the basis of image data obtained by reducing image density of a part using the color configured by the plurality of toners.

10. The image forming system according to claim 1, wherein, when the image formation color selected by the hardware processor and used for forming at least a part of the foil stamping image is a color configured by a plurality of the toners of different colors, the foil transfer reduces a transfer speed of the foil and transfers the foil.

11. An image forming method, which is performed in an image forming system for performing foil stamping printing, comprising an image former comprising a plurality of imaging units that form an image by toners of different colors and a foil transfer that transfers a foil onto a foil stamping image, which is formed by the image former and is the image by the toners, the image forming method comprising:
(a) receiving various types of setting regarding the foil stamping printing;
(b) selecting an image formation color, which is a color to be used for forming the foil stamping image on the basis of the setting received in step (a); and
(c) causing the image former to form the foil stamping image by using the toner of a color corresponding to the image formation color selected in step (b).

12. The image forming method according to claim 11, wherein in the step (c), the foil stamping image is formed on the basis of image data obtained by replacing a color used in image data to be used for forming the foil stamping image with the image formation color selected in the step (b).

13. The image forming method according to claim 11, wherein in the step (a), setting of a thickness of the foil used in the foil transfer is received, and the step (b) comprises:
(d) preferentially selecting a transparent color as the image formation color when the plurality of imaging units include an imaging unit for forming an image by the toner of the transparent color and setting that the thickness of the foil is thin is received in the step (a).

14. The image forming method according to claim 11, wherein in the step (a), setting of a foil color, which is a color of the foil used in the foil transfer, is received, and the step (b) comprises:
(e) selecting the foil color received in the step (a) or a color near the foil color as the image formation color.

15. The image forming method according to claim 11, wherein in the step (a), setting that the image formation color used for forming an end portion of the foil stamping image is changed to a color different from the image formation color used for forming portions other than the end portion is received, and the step (b) comprises:
(f) changing the image formation color used for forming the end portion to a transparent color when the plurality of imaging units include an imaging unit for forming an image by the toner of the transparent color and setting that the image formation color used for forming the end portion is changed to the transparent color is received in the step (a).

16. The image forming method according to claim 11, wherein in the step (a), setting of a foil color, which is a color of the foil used in the foil transfer, and setting of a thickness of the foil used in the foil transfer are received, and the step (b) comprises:
(d) preferentially selecting a transparent color as the image formation color regardless of the received setting of the foil color when the plurality of imaging units include an imaging unit for forming an image by the toner of the transparent color and setting that the thickness of the foil is thin is received in the step (a); and
(e) selecting the received foil color or a color near the foil color as the image formation color when the setting that the thickness of the foil is thin is not received in the step (a).

17. The image forming method according to claim 16, wherein in the step (a), setting that the image formation color used for forming an end portion of the foil stamping image is changed to a color different from the image formation color used for forming portions other than the end portion is further received, and the step (b) comprises:
(g) after preferentially selecting the transparent color as the image formation color in the step (d), changing the image formation color used for forming the end portion to the foil color or the color near the foil color when setting that the image formation color used for forming the end portion is changed to the foil color or the color near the foil color is received in the step (a); and
(f) after selecting the foil color or the color near the foil color as the image formation color in the step (e), changing the image formation color used for forming the end portion to the transparent color when setting that the image formation color used for forming the end portion is changed to the transparent color is received in the step (a).

18. The image forming method according to claim 11, wherein the step (b) further comprises:
(h) determining whether the image former comprises an imaging unit for forming an image by the toner of the image formation color to be selected; and
(i) selecting a yellow color as the image formation color when the image former is determined to not comprise the imaging unit in the step (h).

19. The image forming method according to claim 11, wherein, when the image formation color selected in the step (b) and used for forming at least a part of the foil stamping image is a color configured by a plurality of the toners of different colors, the foil stamping image is formed on the basis of image data obtained by reducing image density of a part using the color configured by the plurality of toners in the step (c).

20. The image forming method according to claim 11, further comprising:
(j) causing the foil transfer to reduce a transfer speed of the foil and transfer the foil when the image formation color selected in the step (b) and used for forming at least a part of the foil stamping image is a color configured by a plurality of the toners of different colors.
